(19) United States
(12) Patent Application Publication
(10) Pub. No.: US 2014/0278362 A1
(43) Pub. Date: Sep. 18, 2014

(54) Entity Recognition in Natural Language Processing Systems

(71) Applicant: INTERNATIONAL BUSINESS MACHINES CORPORATION, Armonk, NY (US)

(72) Inventors: John K. Gerken, III, Apex, NC (US); John M. Prager, Pomona, NY (US); Fiodar Zboichyk, Cary, NC (US)

(73) Assignee: INTERNATIONAL BUSINESS MACHINES CORPORATION, Armonk, NY (US)

(21) Appl. No.: 13/843,377

(22) Filed: Mar. 15, 2013

(51) Int. Cl. G06F 17/27; G06F 17/28

(52) U.S. Cl. CPC G06F 17/2735; G06F 17/28
USPC 704/9; 704/10

(57) ABSTRACT

Mechanisms are provided for generating a dictionary data structure for analytical operations. A source terminology resource is ingested to generate a hierarchical representation of the source terminology resource comprising nodes for terms related to concepts in the source terminology resource. For a node of the nodes in the hierarchical representation of the source terminology resource, a permutation of a corresponding term associated with the node is generated. An expanded hierarchical representation of the source terminology resource is generated based on the generated permutation. An enhanced dictionary data structure is generated based on the expanded hierarchical representation and output to an analytics engine to perform analysis of a corpus of information using the enhanced dictionary data structure.

### BACKGROUND

The present application relates generally to an improved data processing apparatus and method and more specifically to mechanisms for improving entity recognition in natural language processing systems.

Natural language processing (NLP) is a field of computer science, artificial intelligence, and linguistics concerned with the interactions between computers and human (natural) languages. As such, NLP is related to the area of human—computer interaction. Many challenges in NLP involve natural language understanding, i.e. enabling computers to derive meaning from human or natural language input.

Modern NLP algorithms are based on machine learning, especially statistical machine learning. The paradigm of machine learning is different from that of most prior attempts at language processing. Prior implementations of language-processing tasks typically involved the direct hand coding of large sets of rules. The machine-learning paradigm calls instead for using general learning algorithms, often, although not always, grounded in statistical inference, to automatically learn such rules through the analysis of large corpora of typical real-world examples. A corpus (plural, “corpora”) is a collection of textual material, such as a set of documents, portions of one or more documents, or sometimes, individual sentences. A training corpus may be such a collection of textual material that has been annotated with the correct values to be learned during a machine learning process.

Many different classes of machine learning algorithms have been applied to NLP tasks. These algorithms take as input a large set of “features” that are generated from the input data. Some of the earliest-used algorithms, such as decision trees, produced systems of hard if-then rules similar to the systems of hand-written rules that were then common. Increasingly, however, research has focused on statistical models, which make soft, probabilistic decisions based on attaching real-valued weights to each input feature. Such models have the advantage that they can express the relative certainty of many different possible answers rather than only one, producing more reliable results when such a model is included as a component of a larger system.

### SUMMARY

In one illustrative embodiment, a method, in a data processing system comprising a processor and a memory, for generating a dictionary data structure for analytical operations. The method comprises ingesting, by the data processing system, a source terminology resource to generate a hierarchical representation of the source terminology resource comprising nodes for terms related to concepts in the source terminology resource. The method further comprises generating, by the data processing system, for a node of the nodes in the hierarchical representation of the source terminology resource, a permutation of a corresponding term associated with the node. Moreover, the method comprises generating, by the data processing system, an expanded hierarchical representation of the source terminology resource based on the generated permutation. In addition, the method comprises generating, by the data processing system, an enhanced dictionary data structure based on the expanded hierarchical representation, and outputting, by the data processing system, the enhanced dictionary data structure to an analytics engine to perform analysis of a corpus of information using the enhanced dictionary data structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an example diagram illustrating a graph representation of a portion of an ingested terminology source;

FIG. 4 is an example diagram illustrating a first operation for generating permutations of terms in a portion of the graph representation of FIG. 3;

FIG. 5 is an example diagram illustrating a second operation for generating permutations of terms in the graph representation of FIG. 4;

FIG. 6 is a flowchart outlining an example operation for generating enhanced semantic dictionaries in accordance with one illustrative embodiment; and

FIG. 7 is an example block diagram of an enhanced semantic dictionary generation engine in accordance with one illustrative embodiment.

### DETAILED DESCRIPTION

The success or failure of a Natural Language Processing (NLP) mechanism in returning correct or useful results is often tied to the NLP mechanism's ability to extract or identify entities in the corpus to which it is applied. The entity extraction/identification of NLP mechanisms is often limited by the term dictionaries that are used to perform such entity extraction/identification. This is especially true for medicine, finance, and other industries where industry specific terms are often codified, but for which many permutations are used in practice that hold identical meaning to the codified term. Even using “comprehensive” references, such as Systematized Nomenclature of Medicine Clinical Terms (SNOMED CT), which is a systematically organized computer processable collection of medical terms, is not sufficient because these “comprehensive” references do not adequately address the many uses and forms a given term may take. This results in suboptimal annotation results by annotators, where an “annotator” is a program that takes a portion of input text, extracts structured information from it, and generates annotations, or metadata, that are attached by the annotator to the source/original text data. The term “annotation” refers to the process followed by the annotator and the resulting metadata that provides elements of structure that can be referenced or acted upon by other programs, annotators, or the like, that read and understand the annotated text data.

Even when building a dictionary of terms and derivations from a reference such as SNOMED CT, and then supplementing the dictionary with terms from other references such as the Health Language, Inc. language engine (HLI LE) which provides manually entered synonyms for medical terminology, the resulting dictionary still does not capture the many permutations of terms seen in the corpus of documentation processed by the NLP mechanism. Manual enrichment of the terminology is complicated by the fact that terminologies are a constant work in progress. For example, SNOMED CT is updated twice a year, while certain parts of Unified Medical Language System (UMLS, which includes SNOMED CT), such as the drug dictionary RxNorm, are updated approximately every month. Thus, an improved mechanism for building dictionaries is crucial to improving the fidelity of natural language processing analytical activities on unstructured content of a corpus of documents.

The illustrative embodiments provide mechanisms for improving entity recognition in natural language processing systems. In particular, the illustrative embodiments provide mechanisms for building an enhanced semantic dictionary that not only provides a more comprehensive concept content, but also produces the enhanced semantic dictionary (ESD) in a Resource Description Framework (RDF) form that enables the relationships between the typed concepts to be codified. Dictionaries of this structure type provide a much richer basis upon which to write annotators because the concepts and the relationships amongst the concepts are modeled in a standardized manner.

In generating the ESD, the mechanisms of the illustrative embodiments ingest a terminology source, such as the SNOMED CT, RxNorm, or other input dictionary or terminology source, which may involve performing natural language processing on the terminology source to generate a graph representation of the terms specified in the terminology source. The graph comprises nodes for each of the concepts and arcs linking the nodes that have conceptual relationships. Each concept has one of more terms (natural language descriptions) associated with it. Terms in the ontology represented by the graph data structure are identified and permutations of these terms are identified. These permutations may take many different forms, including changing the part of speech of one or more words in the term, changing the order of words in a term using grammatical transpositions, identifying corresponding abbreviations for the words in the term, or the term as a whole, etc. In addition, thesaurus information and inflection processing for each of the words of the terms, and the terms themselves, may be used to generate other permutations or related terms. These permutations and related terms may then be added to the parent concept of the term and the graph data structure may be updated to include nodes and arcs for these additional permutations and related terms, thereby generating an enriched terminology graph data structure.

The enriched terminology graph data structure may then be filtered according to various filter criteria, e.g., “all diseases”, “all symptoms”, “all body parts”, etc., to generate separate dictionaries for the various filter criteria, e.g., a dictionary of diseases, a dictionary of symptoms, a dictionary of body parts, etc. These dictionaries may then be stored for use in performing natural language processing (NLP) on a corpus of information, e.g., electronic documents or the like.

In one illustrative embodiment, the mechanisms of the illustrative embodiments may be utilized to provide input dictionaries for natural language processing performed by a question and answer system, such as the Watson™ question and answer system available from International Business Machines (IBM) Corporation of Armonk, N.Y. The Watson™ system is an application of advanced natural language processing, information retrieval, knowledge representation and reasoning, and machine learning technologies to the field of open domain question answering. The Watson™ system is built on IBM's DeepQA™ technology used for hypothesis generation, evidence gathering, analysis, and scoring. DeepQA™ takes an input question, analyzes it, decomposes the question into constituent parts, generates one or more hypotheses based on the decomposed question and results of a primary search of answer sources, performs hypothesis and evidence scoring based on a retrieval of evidence from evidence sources, performs synthesis of the one or more hypotheses, and based on trained models, performs a final merging and ranking to output an answer to the input question along with a confidence measure. A description of the Watson™ system may be found in the document by Michael J. Yuan entitled “Watson and Healthcare,” Apr. 12, 2011, available at the IBM developerWorks website, which is hereby incorporated by reference. Of course the mechanisms of the illustrative embodiments may be used with any system that requires a terminology dictionary as input for performing its functionality, and especially with regard to any natural language processing system.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With particular importance to the illustrative embodiments described herein, one or more of the server computing devices 104, 106 may have an associated natural language processing (NLP) engine 150 which may be implemented in a separate computing device or integrated into the server computing device 104, 106. The NLP engine 150 may operate on a corpus of information, such as a collection of electronic documents or the like. The NLP engine 150 may be part of an analysis mechanism which uses the natural language processing to perform analysis of a corpus of information to perform a function. In one illustrative embodiment, this analysis mechanism may be a question and answer system, such as the Watson™ question and answer system. In accordance with the illustrative embodiments, an enhanced semantic dictionary (ESD) generation engine 160 may be provided in association with the NLP engine 150, either in a separate computing device, integrated with the NLP engine 150, or the like, which operates on one or more terminology sources 170, e.g., input electronic dictionaries, electronic thesaurus, and/or the like, to generate one or more enhanced semantic dictionaries (ESDs) for use by the NLP engine 150. The detailed operation of the ESD generation engine 160 will be described hereafter with regard to FIGS. 3-7.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

Referring again to FIG. 1, the enhanced semantic dictionary (ESD) generation engine 160 operates on one or more terminology sources 170 to generate one or more ESDs 180 for use by the NLP mechanism 150. The ESD generation engine 160 generates these one or more ESDs 180 by analyzing the terminologies in the terminology sources 170, identifying permutations and related terms to these terminologies, generating an enhanced terminology graph representation, and then filtering this enhanced terminology graph representation based on various filter criteria to generate one or more ESDs 180 comprising terminologies specific to the concepts corresponding to the filter criteria.

A terminology typically consists of concepts that can be expressed in several different ways, referred to herein as “forms,” though one of them is usually a preferred form. For example, “cardiac infarction”, “infarction of heart”, “heart attack”, and “myocardial infarction” all can be used to describe the same concept, with the latter form being designated as the preferred form. The concepts may be further defined so a form of a more generic concept is usually seen as part of a more specific concept, for example “old myocardial infarction.” In this case, any other forms of “myocardial infarction” can be used to express “old myocardial infarction,” such as “old heart attack.” In addition, there may be synonyms that are not part of the terminology, such as “old” and “previous,” in which case “previous heart attack” can be viewed as yet another form of “old myocardial infarction.”

Furthermore, the ordering of words of a terminology may be lead to different forms of the terminology. For example, “kidney disorder” and “disorder of the kidney” may be considered different forms of each other. Likewise, words of a terminology may have different forms of speech in related forms. For example, the terms “stereoscopy” (noun) and “stereoscopic” (adjective) are morphologically related forms of the same terminology. Moreover, there may be equivalent words that generate different forms of a terminology, such as “kidney” and “renal”. In addition, different inflections of words in a terminology may result in different forms of a terminology.

The illustrative embodiments take into consideration the various alternatives and related terms of terms in a source terminology resource when generating the various permutations of the terms in a source terminology resource for enhancing the dictionaries that may be used by the natural language processing mechanisms. That is, the illustrative embodiments, based on a source term, determines the permutations of the source term by determining reordering of the words in a term, changing the part of speech of words in a term, determining abbreviations for the term or words within the term, determining similar terms, different inflections of terms, and the like. These permutations are used to generate the enhanced semantic dictionaries (ESDs) which provide a more comprehensive basis upon which the natural language processing (NLP) mechanism may perform element extraction from documents in a corpus of information.

As an initial part of the operation of the illustrative embodiments, as mentioned above, a terminology source is ingested and converted to a graphical representation of the terms set forth in the terminology source. For example, in one illustrative embodiment, a medical reference, such as the SNOMED CT, may be electronically ingested and converted to a directed graph representation in which nodes are provided for each of the concepts and the string values for the concept name are represented as strings that have relationships of type “lemma” (preferred form) and “form” (also referred to as alternative forms, surface forms, or alternative surface forms) to the concept node accordingly. Edges between the nodes represent the relationships between the concepts and between concepts and their corresponding forms. The process by which a terminology source is converted to a directed graph of concepts is generally known in the art and thus, a more detailed explanation is not provided herein.

Once the directed graph of the ingested source terminology resource is obtained, each of the nodes in the directed graph is used as a source for generating permutations of the node's string to thereby expand the forms associated with the node as well as the real and implied relationships amongst the nodes represented by edges in the directed graph. As discussed hereafter, this expansion of the forms associated with a node comprises generating related strings for a same concept. These related strings may be generated in a number of different ways including reordering words in the source node string, changing a part of speech of one or more words of the source node string, replacing words in the source node string with equivalent words, introducing corresponding abbreviations for the source node string or words within the source node string, changing the inflection of the source node string, and the like.

Essentially, various permutations of the source node string are identified and used to generate additional related nodes and edges in the directed graph. These additional nodes will have a relationship of type “form” to their source node. The source node itself may have a relationship of type “form” to another node or may be a “lemma” type node. Thus, the process of expanding the directed graph may be applied not only to the original nodes in the original directed graph generated from ingesting the source terminology resource, but also may be applied to the new additional nodes added by way of the analysis and expansion mentioned above. A desired level of expansion may be set to place a stopping point on this expansion, e.g., only three levels of expansion are permitted whereby at most a “lemma” node is expanded to have one or more first “form” node, a first “form” node may be expanded to have one or more second “form” nodes, and a second “form” node may be expanded to have one or more third “form” nodes, thereby providing a three level expansion of the original “lemma” node.

After performing the expansions of nodes based on the identified permutations, an enriched and expanded terminology directed graph is generated that comprises additional nodes for the strings corresponding to these permutations. This enriched and expanded terminology directed graph may then be filtered according to specified filter criteria to identify portions of the enhanced and expanded terminology directed graph to include in various concept specific dictionary data structures. While this filtering may be for different concepts, it should be appreciated that a node, or tree of nodes, within the enhanced and expanded terminology directed graph, may be present in multiple ones of these concept specific dictionaries if the strings associated with the nodes corresponding to the filter criteria for the particular concept specific dictionary. Thus, through this filtering process, the single enriched and expanded terminology directed graph may be used as a source for generating a plurality of concept specific dictionaries that can be used for performing natural language processing for specific concepts.

For example, such filtering may be initiated with regard to a specified concept and the enhanced and expanded terminology directed graph may be “walked down” from a node corresponding to the specified concept following relationship edges from the concept node to related nodes. For example, if the concept is “kidney disease”, then nodes that are a kidney disease and located further down the directed graph but having a direct or indirect relationship with the “kidney disease” node, all the way down to the leaf nodes, will be included in the “kidney disease” dictionary. All of the various forms of the “kidney disease” node may be included in the “kidney disease” dictionary. In this way, concept specific dictionaries are generated, such as “all kidney diseases” as opposed to generic dictionaries of the type “medical terms.”

To further illustrate an example operation of the present invention, consider the example shown in FIG. 3. FIG. 3 is an example diagram illustrating a graph representation of a portion of an ingested terminology source. That is, it is assumed in FIG. 3 that a source terminology resource data structure, such as a medical reference data structure, has a portion of the data structure directed to diseases and, in this particular example, kidney diseases. As can be seen from FIG. 3, this portion of the medical reference data structure has the related concepts of “disease,” “disorder by body site,” “disorder of trunk,” “disorder of abdomen,” “kidney disease,” “structured and functional abnormalities of the kidney,” and “cystic disease of kidney.” These concepts are converted to a directed graph representation as shown in FIG. 3 with each node corresponding to a different concept, and each of these nodes having the type “lemma” meaning that the strings associated with them are the preferred form of the concept. The nodes are ordered in descending order from the generic concept of “disease” (node 320) to the more specific sub-concept of “cystic disease of kidney” (node 310) with edges between the nodes indicating the relationships between the nodes.

In this example, it is assumed that the mechanisms of the illustrative embodiments are applied to enrich and expand the last concept node 310, “cystic disease of kidney” in FIG. 3. It should be appreciated that while the illustrative embodiments will be described with regard to expanding the last concept in the directed graph of FIG. 3, the illustrative embodiments may be further applied to each of the nodes in the directed graph, or any other node or subset of nodes in the directed graph. Such processing with regard to each of the nodes, or subset of nodes, may be performed in a sequential manner, a parallel manner, or the like.

As shown in FIG. 3, the node 310 having source node string “cystic disease of kidney” has only one form and it is its lemma form as well. Initially, natural language processing (NLP) may be applied to the form to identify parts of speech in the string, e.g., nouns, verbs, prepositional phrases, etc. At a basic level, the natural language processing (NLP) applies language rules, structures, and pattern matching for identifying portions of an input text, but may further apply machine learning to the identification of concepts, meaning, and the like, in an input portion of text. In this case, the parts of speech identification performed on the string “cystic disease of kidney” identifies the prepositional phrase “disease of kidney,” the nouns “disease” and “kidney”, and the adjective “cystic”.

Based on the identification of parts of speech within a given string of text, the permutation logic of the illustrative embodiments applies rules to these parts of speech to generate permutations of the original source string for the node that maintain the meaning of the original source string for the node. Thus, in this example, the permutation logic of the illustrative embodiments may generate a replacement for the prepositional phrase that is “kidney disease” leading to an alternative form of “cystic kidney disease” as shown in FIG. 4. This replacement may be generated by reordering the words in the prepositional phrase and removing any prepositions, such as “of”, and articles, such as “the,” etc. The removal process is known as “stopword removal” and is well-known in the art.

FIG. 4 is an example diagram illustrating a first operation for generating permutations of terms in the graph representation of FIG. 3. As shown in FIG. 4, through operation of the permutation logic of the illustrative embodiments, a new node 410 is generated that has the associated string “cystic kidney disease” by applying permutation rules to the prepositional phrase of the original string for node 310. The resulting string “cystic kidney disease” is associated with a new node 410 that has a “form” type relationship with the original lemma node 310 “cystic disease of kidney.” It should be appreciated that “lemma” nodes, in this example, correspond to the original concepts identified from the source terminology resource, whereas “form” type nodes, in this example, correspond to various forms of the concept that are generated through the permutation logic of the illustrative embodiments. It should be noted that, in some illustrative embodiments, there are “forms” that can come from the source terminology itself that provide several terms, designating one of them as “preferred” and others as “forms” of the “preferred” form. When the directed graph representation is generated, the whole concept is created as a node and the “preferred” form is attached via a “lemma” relationship and all other forms are attached as a “form” relationship.

It should be noted that while FIGS. 3-4 illustrate the conversion of an identified prepositional phrase to an alternative form, e.g., “disease of kidney” to “kidney disease,” an opposite conversion, or transformation, of the string may be performed to convert an original string that does not have a prepositional phrase to one that does, or to convert one prepositional phrase to another. For example, With regard to the node “kidney disease,” the natural language processing may identify the string as containing two nouns, “kidney” and “disease”, and may further identify a rule that states that if the string comprises only two nouns, it is possible to convert the string to a permutation comprising a prepositional phrase by inserting a preposition between the nouns and reordering the nouns. Thus, for example, the permutation logic may generate a prepositional phrase using these two nouns “kidney” and “disease” by reordering the nouns and introducing a proposition “of” and one or more articles into the original string to generate the new string “disease of kidney.” Thus, if the original node was “cystic kidney disease”, through operation of the permutation logic of the illustrative embodiments, the string “cystic disease of kidney” may be generated and would then be associated with a new node with a relationship of “form” type with the original concept node.

In addition, based on the natural language processing of the strings associated with the nodes, the permutation logic of the illustrative embodiments may identify synonyms for words used in the strings and may generate permutations based on the identified synonyms. These synonyms may themselves be single words or may be phrases that are essentially the same in meaning as the words with which they are associated. For example, as shown in FIG. 4, the original node 420 has an associated string of “kidney disease.” The term “disease of” may have a synonym of “disorder of” leading to the form node 430 having string “disorder of kidney”. Moreover, the entire phrase “kidney disease” may have a synonym of “nephrosis” leading to the form node 440 having the string “nephrosis.” The identification of synonyms may be performed using any suitable input thesaurus, dictionary, listing of associated terms, or the like, which the permutation logic may use when identifying words and phrases in a string associated with a node and then performing a lookup operation to identify the synonyms of the words and phrases.

In a further operation of the permutation logic, the permutation logic of the illustrative embodiments identifies concepts, associated with related nodes to the node 310 being processed, that are fully contained in the strings associated with the original concept node 310 that is being processed and/or its associated form nodes 410. These concept nodes that are fully contained in the nodes being processed are typically nodes that are higher up in the directed graph tree structure. A string comparison can be performed between the strings of the nodes above the currently being processed node, e.g., node 310, and the strings of the currently processed nodes and any “form” nodes, e.g., node 410, that have been generated for the node 310 being processed. If another node has a concept, represented by its associated string, that is fully contained in the node being processed 310, or one of its form nodes 410, then the form nodes associated with that matching node may be used to generate additional permutations for the node being processed 310.

In the depicted example, the newly generated node 410 has the string “cystic kidney disease” which includes the fully contained concept “kidney disease” which matches the concept/string of node 420 higher up in the directed graph. That is, the concept “kidney disease” associated with node 420 is fully contained within the newly generated node 410. The other forms of the “kidney disease” node 420, i.e. “disorder of kidney” and “nephrosis”, which may have been generated through a prior application of the permutation logic of the illustrative embodiments or may have been specified in the original source terminology resource data structure, may be used to generate additional permutations of the node 410.

FIG. 5 is an example diagram illustrating a second operation for generating permutations of terms in the graph representation of FIG. 4. As shown in FIG. 5, the concept “kidney disease” associated with node 420 is wholly contained within the concept/string “cystic kidney disease” of node 410. Thus, the related form nodes 430 and 440 are used to generate permutations of the string associated with the node 410, which wholly contains the concepts/strings of the form nodes 430 and 440. Thus, for example, node 510 is added as a child form node of the original node 310 and has the associated string “cystic disorder of kidney” generated by replacing the term “kidney disease” in the string “cystic kidney disease” associated with node 410 with the term “disorder of kidney” associated with the node 430. Similarly, node 520 is added as a child form node of the original node 310 and has the associated string “cystic nephrosis” generated by replacing the term “kidney disease” in the string “cystic kidney disease” associated with node 410 with the term “nephrosis” associated with the node 440.

Thus far, the permutation logic generates permutations by performing natural language processing on the original node concepts/strings to identify the parts of speech of the words/phrases in the concepts/strings, and then performing transformations on these concepts/strings based on the natural language processing. These transformations involve reordering the words in the concept/string, introducing and/or rewording prepositional phrases in the concepts/strings, identifying synonyms to words/phrases in the concepts/strings and replacing the words/phrases with their synonyms to generate permutations, and performing concept/string replacement using form nodes associated with other concepts/strings of other nodes in the directed graph based on whether a concept/string is wholly included in the concept/string of the node being processed. In the context of this description the “concept” is represented by a node that is the “lemma” node for the concept, which is an abstract idea realized in language by the various strings of the lemma node or nodes connected to the lemma node.

As mentioned above, in addition to re-using concepts/strings from other nodes that are wholly included in a node being processed, outside sources, such as a thesaurus, dictionary, listing of similar terms, or the like, may be used as an additional source of information for the permutation logic to identify known alternatives to a given word or phrase in a concept/string. For example, a known synonym of “disease” is “illness” even though this synonym may not be provided in the original source terminology resource that is ingested. Using such outside sources from the source terminology resource that is ingested may lead to forms such as “cystic kidney illness”, “cystic illness of kidney”, etc. Thus, additional permutations of the concept/string may be generated and corresponding nodes may be added to the directed graph to represent these additional forms. A lookup of words/phrases in these outside sources based on the identified words/phrases in the concepts/strings of the nodes may be used to generate these additional permutations.

Furthermore, the illustrative embodiments may make use of inflection rules to apply inflections to individual words in a concept/string, or the concept/string as a whole, to generate additional permutations. For example, one inflection rule may be to generate a plural form of a last noun in a concept/string. Thus, for example, the concept/string “cystic kidney disease” associated with node 410 may be transformed into “cystic kidney diseases” and a corresponding additional node may be generated and added to the directed graph as a child form of the node 410, for example. The same can be done for “cystic kidney disorders,” “cystic diseases of kidney”, and “cystic disease of kidneys”. Essentially, the inflection logic of the permutation logic may find the nouns in a concept/string and generate new concepts/strings in which one or more of the nouns are pluralized.

In addition to the above permutations, the permutation logic may comprise transformer logic for transforming noun-based concepts/strings into adjective based concepts/strings. For example, the concept/string “pain in the abdomen” or “abdomen pain” may be transformed by the transformer logic to a concept/string of “abdominal pain.” This involves taking the nouns identified through the natural language processing of concepts/strings, and converting them to their corresponding adjectives, e.g., “abdomen” to “abdominal.” Of course, while this description will discuss converting nouns to corresponding adjectives, the transformer logic may have similar functionality for converting adjectives to their corresponding nouns and thereby generate other permutations in which adjectives are replaced with their noun equivalents.

The transformation of nouns into their corresponding adjective counterparts may take different forms. In one illustrative embodiment, the transformer logic may look to an outside lexical resource, such as WordNet or the like, which gives meanings of, and relations between, nouns, verbs, adjectives, and adverbs. One of the relationships found in such a lexical resource may be a link between a noun and the corresponding related adjective. Such pairs are not strictly synonyms, since they are not generally directly substitutable for each other (e.g., “red” and “redness”), but they are clearly semantically related, and are substitutable when accompanied by the syntactic transformations such as in the example above. For example, based on a natural language processing analysis of the concept/string “pain in the abdomen”, rules may be applied that cause the transformer logic to reorder the terms to “abdomen pain”, eliminating the preposition and article, and then transform the noun “abdomen” to its adjective counterpart “abdominal” thereby generating the permutation “abdominal pain.” A corresponding node may be generated and added to the enhanced and expanded directed graph.

In another illustrative embodiment, if an outside lexical source does not provide a mapping between noun and adjective, or if an outside lexical source is not available, a heuristic may be used based on similar-looking words. The basis for this mechanism is the observation that lexically-similar words tend to have the same morphology.

This mechanism generates morphologically related forms. For example, if there is no link between the terms “colonoscopy” and “colonoscopic”, between terms “microscopy” and “microscopic”, or between “telescopy” and “telescopic” in an outside lexical source, a set of permutation rules may be applied to the noun to generate the adjective or vice versa. That is, if the noun is detected through the natural language processing, and an attempt to find a mapping in an outside lexical source fails, or there is no outside lexical source available, then permutation rules may be applied to change the suffix of the noun to generate the adjective, e.g., “colonoscopy” to “colonoscopic.” The algorithm applying these permutation rules may require a threshold number of validating examples, although a threshold of 1 is possible, with the optimum threshold for a domain being determined using a set of test cases. As an example, consider the term “colonoscopy.” There may be 2 validating examples for “colonoscopy” which are “telescopy” and “microscopy.” These terms look similar and their adjectives look similar. Through a empirical process it may be determined that for the medical domain, as opposed to other domains such as finance or the like, 2 validating examples may not be sufficient and, instead, 3 validating examples are required. Therefore, 3 may be the threshold number for the domain “medicine.” Thus, if there are at least 3 similarly looking non-adjective pairs, then the corresponding adjective permuation for colonscopy may be utilized, e.g., “colonoscopic” based on the adjectives “telescopic” and “microscopic” in the validating examples.

It should be appreciated that the permutation logic may generate many different permutations based on the application of the various operations and various permutation rules. For example the permutation logic may generate a chain of permutations such as “construction” to “constructive” to “constructible”. Thus, several permutation terms may be generated by the permutation logic and added to the overall enhanced and expanded directed graph.

It should be noted that, through the automated generation of permutations of concepts/strings performed by the permutation logic of the illustrative embodiments, some forms of a concept/string that are not used in practice may be generated and added to the directed graph of the ingested source terminology resource. Even though this may impact the performance of the system as a whole, this performance impact is expected to be minimal and greatly outweighed by the increased accuracy obtained from the use of the resulting dictionaries. That is, as this is a pre-processing step to generate dictionaries that are then used for element extraction by analysis engines, the resulting accuracy of these analysis engines greatly outweighs the slight performance degradation encountered during the dictionary generation. Furthermore, it should be appreciated that dictionary matching logic can be very simple and thus, extremely fast. By shifting the complex processing from run-time to build-time using the mechanisms of the illustrative embodiments, increased accuracy is achieved while maintaining good performance. In order to maintain the dictionary size at a manageable level, limits on the size of the dictionary may be imposed. However, in some illustrative embodiments, the mechanisms of the illustrative embodiments may be implemented at runtime in which case all possible permutations may be utilized without limitations thereby achieving even greater accuracy but with possible sacrifices in performance. Whether or not to use the mechanisms of the illustrative embodiments during build-time or runtime is driven by the requirements of the particular system in which the illustrative embodiments are implemented.

In one illustrative embodiment, confidence scoring may be used to assist in identifying improper concepts/strings in the directed graph and the resulting dictionaries. In such a case, concepts/strings that are less frequently encountered during application of the dictionaries to the analysis engines may be pruned from the directed graph and the dictionaries utilized by the analysis engines. Thus, as an additional step, prior to either generating a concept specific dictionary, or prior to deploying the concept specific dictionary for use by an analysis engine, is to compare concepts/strings in the enhanced and expanded directed graph data structure to statistical information gathered by the analysis engine for concepts/strings encountered by the analysis engine during its analysis operations, and determine if any of the concepts/strings in the enhance and expanded directed graph data structure have an statistical measure less than a predetermined threshold. If so, then the nodes corresponding to those concepts/strings, and any of their child form nodes, may be removed from the enhanced and expanded directed graph data structure. In this way, permutations that are not actually used in practice may be pruned from the enhanced and expanded directed graph data structure and the resulting concept specific dictionaries.

Thus, the illustrative embodiments provide mechanisms for expanding a directed graph representation of a source terminology resource to include permutations of the terminologies. The resulting enhanced and expanded directed graph representation may then be filtered to extract one or more concept specific dictionaries. That is, the directed graph may be processed according to one or more filter criteria that may be matched to the concepts/strings associated with nodes of the enhanced and expanded directed graph as discussed above. The resulting subsets of nodes may be used to define a directed graph of a concept specific dictionary. These concept specific dictionaries may be used by analytic engines to process a corpus of information. In one illustrative embodiment, these concept specific dictionaries may be used as input to a question and answer system, such as Watson™, to assist in processing a corpus of information to extract elements from the documents in the corpus of information. For example, the Watson™ system may utilize natural language processing (NLP) to identify the entities and their types in both questions and a corpus of information in order to attempt to identify answers to input questions. As part of this NLP processing, the Watson™ system may make use of the dictionaries generated by way of the mechanisms of the illustrative embodiment to perform such NLP processing.

FIG. 6 is a flowchart outlining an example operation for generating enhanced semantic dictionaries in accordance with one illustrative embodiment. As shown in FIG. 6, the operation starts by ingesting a source terminology resource, comprising a plurality of terms which may be generic terms or specific to a particular domain, e.g., medical terminology, specific industry terminology, or the like (step 610). A directed graph representation of the concepts/terms in the source terminology resource is generated (step 620). Thereafter, permutation logic is applied to every concept and term in the directed graph representation to generate permutations of each of the concepts and terms (step 630). As described above, this process may involve generating various types of permutations including reordering of words in concepts/strings, replacing words of concepts/terms with synonyms, changing the part of speech of words in the concepts/strings, generating different inflections of the concepts/strings, changing nouns to adjectives or adjectives to nouns, etc.

As a result of the generation of the various permutations of the concepts/terms in the directed graph representation, an enhanced and expanded directed graph is generated (step 640). One or more filters may be applied to the nodes of the enhanced and expanded directed graph (step 650) to generate one or more concept specific dictionaries (step 660). These one or more concept specific enhanced semantic dictionaries are then output for use by an analytics engine (step 670). The analytics engine applies the one or more concept specific enhanced semantic dictionaries to natural language processing of a corpus of information (step 680). The operation then terminates.

FIG. 7 is an example block diagram of an enhanced semantic dictionary generation engine in accordance with one illustrative embodiment. As shown in FIG. 7, the enhanced semantic dictionary generation engine 700 includes a source terminology resource ingestion engine 710, a permutation engine 720, an outside source interface 730, a concept specific dictionary generation engine 740, and an analytics engine interface 750. The permutation engine 720 further comprises permutation logic including word reordering logic 722, prepositional phrase transformation logic 724, synonym replacement logic 726, inflection logic 728, and noun/adjective transformation logic 729. Additional logic for additional transformations and permutation generation may be included in the permutation engine 720, either in addition to or in replacement of one or more of the logics 722-729 shown in FIG. 7, without departing from the spirit and scope of the illustrative embodiments.

The source terminology resource ingestion engine 710 receives as input a source terminology resource 702 and generates a hierarchical representation of the source terminology resource, such as a directed graph of concepts/terms in the source terminology resource 702, which is stored as ingested source terminology resource data structure 712. The source terminology resource ingestion engine 710 may apply natural language processing techniques to the source terminology resource 702 to identify the parts of speech of concepts/terms included in the source terminology resource 702. The permutation engine 720 operates on the ingested source terminology resource data structure 712 to generate permutations of the concepts/strings associated with nodes in the ingested source terminology resource data structure 712 to generate an enhanced and expanded terminology hierarchical representation 760. The permutation engine 720 operates to implement the various permutation generation operations previously described above with regard to FIGS. 3-6.

In particular, the word reordering logic 722 may reorder words in concepts/strings of nodes in the ingested source terminology resource data structure 712 to generate permutations of the concepts/strings. The prepositional phrase transformation logic 724 generates permutations of prepositional phrases, such as described above with regard to FIG. 4, for example, and further may perform operations to identify concepts that are fully contained within the concepts/strings of other nodes, such as described above with regard to FIG. 5, for example. The synonym replacement logic 726 replaces words in the concepts/strings of nodes in the ingested source terminology resource data structure 712 with their synonyms or similar terms. The synonym replacement logic 726 may make use of one or more outside synonym resources 770, e.g., dictionaries, thesaurus, listing of similar terms, etc., to assist with such synonym identification and replacement by performing lookup operations in these outside synonym resources 770.

The inflection logic 728 generates permutations of the concepts/strings of the nodes in the ingested source terminology resource data structure 712 by generating different inflections of the concepts/strings associated with the nodes. The noun/adjective transformation logic 729 generates permutations of the concepts/strings of the nodes in the ingested source terminology resource data structure 712 by converting nouns to adjectives or adjectives to nouns and rewording the concepts/strings accordingly. The noun/adjective transformation logic 729 may make use of one or more outside lexical sources 780 for assisting in identifying a mapping between nouns and adjective forms of the nouns, and vice versa. Thus, the permutation engine 720 generates a plurality of permutations of the various concepts/strings associated with nodes in the ingested source terminology resource data structure 712. In this way, the permutation engine 720 generates an enhanced and expanded terminology hierarchical representation 760.

The outside source interface 730 provides an interface through which the permutation engine 720 may access outside sources of information for use in assisting with the generation of permutations, such as outside synonym resources 770 and outside lexical sources 780. The concept specific dictionary generation engine 740 may apply one or more filters to the enhanced and expanded terminology hierarchical representation 760 to thereby generate one or more concept specific dictionaries 790. These one or more concept specific dictionaries 790 may then be output to one or more analytics engines 795, via the analytics engine interface 740, for use in performing analytical operations, such as natural language processing of a corpus of information, or the like.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system comprising a processor and a memory, for generating a dictionary data structure for analytical operations, comprising:
ingesting, by the data processing system, a source terminology resource to generate a hierarchical representation of the source terminology resource comprising nodes for terms related to concepts in the source terminology resource;
generating, by the data processing system, for a node of the nodes in the hierarchical representation of the source terminology resource, a permutation of a corresponding term associated with the node;
generating, by the data processing system, an expanded hierarchical representation of the source terminology resource based on the generated permutation;
generating, by the data processing system, an enhanced dictionary data structure based on the expanded hierarchical representation; and
outputting, by the data processing system, the enhanced dictionary data structure to an analytics engine to perform analysis of a corpus of information using the enhanced dictionary data structure.

2. The method of claim 1, wherein generating the permutation of the corresponding term associated with the node comprises at least one of changing a part of speech of the term, changing an order of words in the term using a grammatical transposition, identifying a corresponding abbreviation for a word or words in the term or the term as a whole, performing inflection processing on a word or words of the term, or determining a synonym for a word or words of the term.

3. The method of claim 1, further comprising:
filtering the enhanced dictionary data structure according to a specified concept to generate a concept specific dictionary data structure that comprises a subset of the enhanced dictionary data structure.

4. The method of claim 3, wherein the filtering of the enhanced dictionary data structure is performed with regard to a plurality of specified concepts to generate a plurality of concept specific dictionaries, and wherein outputting the enhance dictionary data structure to the analytics engine comprises outputting the plurality of concept specific dictionaries to the analytics engine to perform analysis of the corpus of information based on concepts identified in the corpus of information corresponding to concepts of the plurality of concept specific dictionaries.

5. The method of claim 1, wherein the analytics engine is a question and answer system, and wherein the enhanced dictionary data structure is used by the question and answer system to extract elements from input questions and a corpus of information used to generate answers for the input question.

6. The method of claim 1, wherein the analytics engine is a Natural Language Processing (NLP) engine, and wherein the analysis performed by the analytics engine is a NLP of the corpus of information using the enhanced dictionary data structure to extract elements from the corpus of information.

7. The method of claim 1, wherein generating, for the node of the nodes in the hierarchical representation of the source terminology resource, the permutation of the corresponding term associated with the node comprises:
performing natural language processing of the term to identify parts of speech in the term; and
generating the permutation of the term based on modifying the identified parts of speech in the term.

8. The method of claim 7, wherein generating the permutation of the term based on modifying the identified parts of speech in the term comprises applying one or more permutation rules based on the identified parts of speech in the term to modify the identified parts of speech by at least one of reordering words in a prepositional phrase of the term, converting a noun in the term to a corresponding adjective, converting an adjective in the term to a corresponding noun, inserting a preposition between two nouns identified in the term, removing a preposition from the term, or replacing one or more words in the term with synonyms for the one or more words in the term.

9. The method of claim 1, wherein generating the permutation of the corresponding term associated with the node comprises utilizing an external lexical source to provide morphologically related forms of the term and replace the term with the morphologically related form to generate the permutation of the corresponding term.

10. The method of claim 1, wherein the method is implemented at a dictionary build time prior to use of the enhanced dictionary data structure at runtime by the analytics engine.

11. The method of claim 1, wherein the method is implemented during runtime execution of the analytics engine.

12. The method of claim 1, further comprising:
defining a size limit for the expanded hierarchical representation of the source terminology resource, wherein:
generating a permutation of a corresponding term associated with the node comprises generating a plurality of permutations for the corresponding term, and
generating an expanded hierarchical representation of the source terminology resource based on the generated permutation comprises generating the expanded hierarchical representation by adding nodes to the hierarchical representation until the size limit for the expanded hierarchical representation of the source terminology resource is reached.

13. A computer program product comprising a computer readable storage medium having a computer readable program stored therein, wherein the computer readable program, when executed on a computing device, causes the computing device to:
ingest a source terminology resource to generate a hierarchical representation of the source terminology resource comprising nodes for terms related to concepts in the source terminology resource;
generate, for a node of the nodes in the hierarchical representation of the source terminology resource, a permutation of a corresponding term associated with the node;
generate an expanded hierarchical representation of the source terminology resource based on the generated permutation;
generate an enhanced dictionary data structure based on the expanded hierarchical representation; and
output the enhanced dictionary data structure to an analytics engine to perform analysis of a corpus of information using the enhanced dictionary data structure.

14. The computer program product of claim 13, wherein the computer readable program causes the computing device to generate the permutation of the corresponding term associated with the node by at least one of changing a part of speech of the term, changing an order of words in the term using a grammatical transposition, identifying a corresponding abbreviation for a word or words in the term or the term as a whole, performing inflection processing on a word or words of the term, or determining a synonym for a word or words of the term.

15. The computer program product of claim 13, wherein the computer readable program further causes the computing device to:
filter the enhanced dictionary data structure according to a specified concept to generate a concept specific dictionary data structure that comprises a subset of the enhanced dictionary data structure.

16. The computer program product of claim 15, wherein the filtering of the enhanced dictionary data structure is performed with regard to a plurality of specified concepts to generate a plurality of concept specific dictionaries, and wherein outputting the enhance dictionary data structure to the analytics engine comprises outputting the plurality of concept specific dictionaries to the analytics engine to perform analysis of the corpus of information based on concepts identified in the corpus of information corresponding to concepts of the plurality of concept specific dictionaries.

17. The computer program product of claim 13, wherein the analytics engine is a question and answer system, and wherein the enhanced dictionary data structure is used by the question and answer system to extract elements from input questions and a corpus of information used to generate answers for the input question.

18. The computer program product of claim 13, wherein the analytics engine is a Natural Language Processing (NLP) engine, and wherein the analysis performed by the analytics engine is a NLP of the corpus of information using the enhanced dictionary data structure to extract elements from the corpus of information.

19. The computer program product of claim 13, wherein the computer readable program causes the computing device to generate, for a node of the nodes in the hierarchical representation of the source terminology resource, the permutation of the corresponding term associated with the node at least by:
performing natural language processing of the term to identify parts of speech in the term; and
generating the permutation of the term based on modifying the identified parts of speech in the term.

20. The computer program product of claim 19, wherein the computer readable program causes the computing device to generate the permutation of the term based on modifying the identified parts of speech in the term at least by applying one or more permutation rules based on the identified parts of speech in the term to modify the identified parts of speech by at least one of reordering words in a prepositional phrase of the term, converting a noun in the term to a corresponding adjective, converting an adjective in the term to a corresponding noun, inserting a preposition between two nouns identified in the term, removing a preposition from the term, or replacing one or more words in the term with synonyms for the one or more words in the term.

21. The computer program product of claim 13, wherein the computer readable program causes the computing device to generate the permutation of the corresponding term associated with the node at least by utilizing an external lexical source to provide morphologically related forms of the term and replace the term with the morphologically related form to generate the permutation of the corresponding term.

22. The computer program product of claim 13, wherein the computer readable program is executed by the computing device at a dictionary build time prior to use of the enhanced dictionary data structure at runtime by the analytics engine.

23. The computer program product of claim 13, wherein the computer readable program is executed by the computing device during runtime execution of the analytics engine.

24. The computer program product of claim 13, wherein the computer readable program further causes the computing device to:
define a size limit for the expanded hierarchical representation of the source terminology resource, wherein the computer readable program causes the computing device to:
generate a permutation of a corresponding term associated with the node at least by generating a plurality of permutations for the corresponding term, and
generate an expanded hierarchical representation of the source terminology resource based on the generated permutation at least by generating the expanded hierarchical representation by adding nodes to the hierarchical representation until the size limit for the expanded hierarchical representation of the source terminology resource is reached.

25. An apparatus, comprising:
a processor; and
a memory coupled to the processor, wherein the memory comprises instructions which, when executed by the processor, cause the processor to:
ingest a source terminology resource to generate a hierarchical representation of the source terminology resource comprising nodes for terms related to concepts in the source terminology resource;
generate, for a node of the nodes in the hierarchical representation of the source terminology resource, a permutation of a corresponding term associated with the node;
generate an expanded hierarchical representation of the source terminology resource based on the generated permutation;
generate an enhanced dictionary data structure based on the expanded hierarchical representation; and
output the enhanced dictionary data structure to an analytics engine to perform analysis of a corpus of information using the enhanced dictionary data structure.
